(19) United States
(12) Patent Application Publication
(10) Pub. No.: US 2018/0356216 A1
(43) Pub. Date: Dec. 13, 2018

(54) DISTANCE MEASURING MODULE, THREE-DIMENSIONAL (3D) SCANNING SYSTEM AND DISTANCE MEASURING METHOD

(71) Applicants: BOE TECHNOLOGY GROUP CO., LTD., Beijing (CN); PEKING UNIVERSITY, Beijing (CN)

(72) Inventors: Yanbing WU, Beijing (CN); Xing ZHANG, Beijing (CN); Yi WANG, Beijing (CN)

(21) Appl. No.: 15/535,649

(22) PCT Filed: Jun. 12, 2016
(86) PCT No.: PCT/CN2016/085416

§ 371 Date: Jun. 13, 2017

(30) Foreign Application Priority Data
Feb. 23, 2016 (CN) 201610099285.8

(51) Int. Cl. G01C 3/06; G01B 11/02

(52) U.S. Cl. CPC G01C 3/06; G01B 11/026

(57) ABSTRACT

A distance measuring module, a three-dimensional (3D) scanning system and a distance measuring method are provided. The distance measuring module includes a camera including: a lens assembly, first and second mirrors, and first and second image sensors. The lens assembly includes a lens group and has an optical axis. The first and second mirrors are configured to reflect imaging light from the lens assembly. The first and second image sensors respectively correspond to the first and second mirrors and are respectively configured to receive imaging light from the first and second mirrors for imaging. The first and second image sensors respectively include first and second photosensitive surfaces. First and second included angles are respectively formed between the first and second photosensitive surfaces and a connecting line of center points of the first and second photosensitive surfaces. At least one of the first included angle or the second included angle is not zero.

### TECHNICAL FIELD

Embodiments of the present disclosure relate to a distance measuring module, a three-dimensional (3D) scanning system and a distance measuring method.

### BACKGROUND

3D scanning technology is a technology that has been widely concerned in recent years. Kinect of Microsoft Corporation, Primsense purchased by Apple Inc., and Realsense widely popularized by Intel Corporation all belong to 3D scanning technology. The basis of the 3D scanning technology is to adopt a 3D scanner to output a distance from a certain object point in front to an original point of the 3D scanner.

### SUMMARY

Embodiments of the present disclosure provide a distance measuring module, a 3D scanning system and a distance measuring method.

According to at least one embodiment of the present disclosure, a distance measuring module is provided, comprising a camera. The camera comprises: a lens assembly; a first mirror and a second mirror; a first image sensor; and a second image sensor. The lens assembly comprises a lens group and has an optical axis. The first mirror and the second mirror are configured to reflect imaging light from the lens assembly. The first image sensor corresponds to the first mirror and receives imaging light from the first mirror for imaging. The first image sensor comprises a first photosensitive surface provided with a first center point. The second image sensor corresponds to the second mirror and receives imaging light from the second mirror for imaging. The second image sensor comprises a second photosensitive surface provided with a second center point. A connecting line of the first center point and the second center point is perpendicular to the optical axis of the lens assembly. The first photosensitive surface and the second photosensitive surface are inclined relative to the connecting line of the first center point and the second center point. A first included angle is formed between the first photosensitive surface and the connecting line. A second included angle is formed between the second photosensitive surface and the connecting line. At least one of the first included angle or the second included angle is not zero.

According to at least one embodiment of the present disclosure, a three-dimensional (3D) scanning system is provided, comprising the distance measuring module.

According to an embodiment of the present disclosure, a distance measuring method using a distance measuring module, comprising: shooting an image of an object to be measured via a camera of the distance measuring module; and determining a vertical distance h from the object to be measured to the camera according to two images of the object to be measured formed in the first image sensor and the second image sensor of the camera. The camera comprises: a lens assembly comprising a lens group and having an optical axis. The camera also comprises a first mirror and a second mirror configured to reflect imaging light from the lens assembly. The first image sensor corresponds to the first mirror and is configured to receive imaging light from the first mirror for imaging. The first image sensor comprises a first photosensitive surface having a first center point. The second image sensor corresponds to the second mirror and is configured to receive imaging light from the second mirror for imaging. The second image sensor comprises a second photosensitive surface having a second center point. A connecting line of the first center point and the second center point is perpendicular to an optical axis of the lens assembly. The first photosensitive surface and the second photosensitive surface are inclined relative to the connecting line of the first center point and the second center point. A first included angle is formed between the first photosensitive surface and the connecting line. A second included angle is formed between the second photosensitive surface and the connecting line. At least one of the first included angle or the second included angle is not zero.

### BRIEF DESCRIPTION OF THE DRAWINGS

Embodiments of the present disclosure will be described in more detail below with reference to accompanying drawings to allow an ordinary skill in the art to more clearly understand embodiments of the present disclosure, in which:

FIG. 1 shows the relationship between the identification distance and the measuring precision of a binocular distance measuring system for large-size products;

FIG. 2 is a schematic structural view of a distance measuring module provided by an embodiment of the present disclosure;

FIG. 3 is a structural block diagram of the distance measuring module provided by an embodiment of the present disclosure;

FIG. 4 is a schematic structural view of another distance measuring module provided by an embodiment of the present disclosure; and

FIG. 5 is a schematic structural view of still another distance measuring module provided by an embodiment of the present disclosure.

### DETAILED DESCRIPTION

In order to make objects, technical details and advantages of the embodiments of the present disclosure apparent, technical solutions according to the embodiments of the present disclosure will be described clearly and fully as below in conjunction with the accompanying drawings of embodiments of the present disclosure. It is apparent that the described embodiments are just a part but not all of the embodiments of the disclosure. Based on the described embodiments herein, a person of ordinary skill in the art can obtain other embodiment(s), without any creative work, which shall be within the scope of the present disclosure.

Unless otherwise defined, all the technical and scientific terms used herein have the same meanings as commonly understood by a person of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not intended to define a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

3D scanning technology for binocular parallax distance measurement is one of the important technologies in stereo vision distance measuring technology, which acquires the distance of an object by a camera to determine the difference of the position of the same object in two imaging pictures.

In binocular parallax distance measurement, the depth is calculated according to the depth of focus, and the farther the object is, the lower the resolution. FIG. 1 shows the relationship between the identification distance and the measuring precision of a binocular stereo vision device (with the binocular distance of 12 cm) for large-size products, in which the x-coordinate represents the distance between the camera and the object, and the y-coordinate represents the distance indicated by the unit data (for example, 1) at this distance. As shown in FIG. 1, the greater the distance between the camera and the object is, the greater the distance represented by the unit data is, namely the lower the measuring precision is. In application, in order to improve the long-distance measuring precision, the distance between two cameras is usually required to be increased. When the distance between the two cameras is greater, the space occupied by a binocular distance measuring device is larger, so the volume of a terminal device for accommodating the binocular distance measuring device is bound to be increased, and the miniaturization and the ultrathin design of the terminal device can be affected.

The distance measuring module, the 3D scanning system including the distance measuring module, and the distance measuring method using the distance measuring module, provided by embodiments of the present disclosure, can improve the distance measuring precision and widen the measuring range without changing the distance between components of the distance measuring module, namely not increasing the size of the distance measuring module.

The distance measuring module includes a camera. The camera includes: a lens assembly, a first mirror, a second mirror, a first image sensor and a second image sensor. The lens assembly includes a lens group and has an optical axis. The first mirror and the second mirror are configured to reflect imaging light from the lens assembly. The first image sensor corresponds to the first mirror and is configured to receive imaging light from the first mirror for imaging. The first image sensor includes a first photosensitive surface having a center point. The second image sensor corresponds to the second mirror and is configured to receive imaging light from the second mirror for imaging. The second image sensor includes a second photosensitive surface having a second center point. A connecting line of the first center point and the second center point is perpendicular to the optical axis of the lens assembly. The first photosensitive surface and the second photosensitive surface are inclined relative to the connecting line of the first center point and the second center point. A first included angle is formed between the first photosensitive surface and the connecting line. A second included angle is formed between the second photosensitive surface and the connecting line. At least one of the first included angle or the second include angle is not zero.

In the distance measuring module, as the first image sensor and the second image sensor are inclined and no longer perpendicular to the optical axis of the lens assembly, the distance from an image point of the same object formed in each of the two image sensors to the center point of the image sensor can be increased. In this way, the distance measuring precision can be improved and the measuring range can be prolonged. The embodiments of the present disclosure can improve the measuring precision on long-distance objects without changing the distance between components of the distance measuring module. The distance measuring precision can be improved without increasing the size of the distance measuring module. The miniaturization and the ultrathin design of the distance measuring module and the 3D scanning system for accommodating the distance measuring module can be realized, and the portability is improved. Detailed description will be given below to the distance measuring module, the 3D scanning system including the distance measuring module, and the distance measuring method using the distance measuring module, provided by embodiments of the present disclosure, with reference to the accompanying drawings.

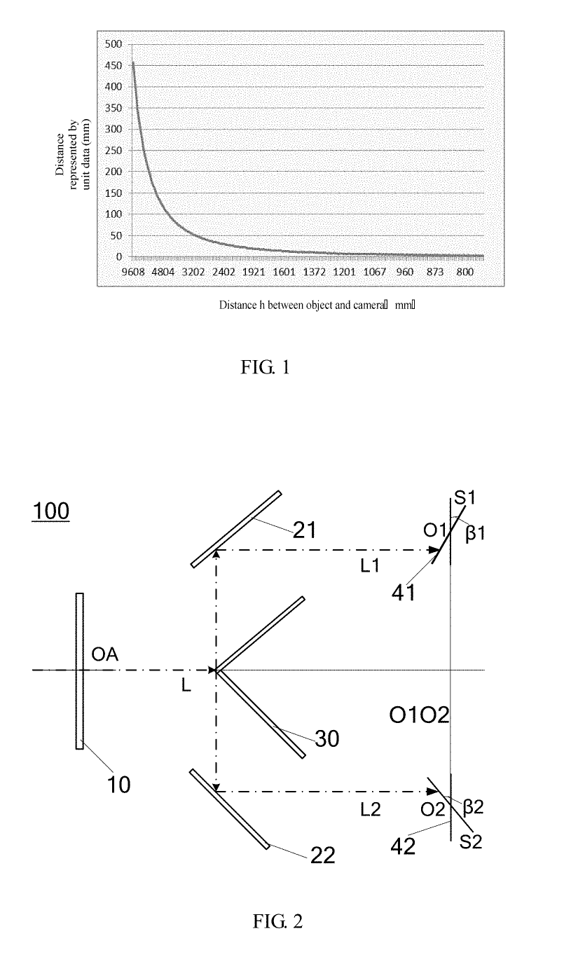

An embodiment of the present disclosure provides a distance measuring module. FIG. 2 is a schematic structural view of the 3D camera module. As shown in FIG. 2, the distance measuring module includes a camera 100. The camera 100 includes: a lens assembly 10, a first mirror 21, a second mirror 22, a first image sensor 41 and a second image sensor 42. The lens assembly 10 includes a lens group and has an optical axis OA. The first mirror 21 and the second mirror 22 are configured to reflect imaging light L from the lens assembly 10. The first image sensor 41 corresponds to the first mirror 21 and receives imaging light L1 from the first mirror 21 for imaging. The first image sensor 41 includes a first photosensitive surface S1 having a first center point O1. The second image sensor 42 corresponds to the second mirror 22 and receives imaging light L2 from the second mirror 22 for imaging. The second image sensor 42 includes a second photosensitive surface S2 having a second center point O2.

Herein, a connecting line O1O2 of the first center point O1 and the second center point O2 is perpendicular to the optical axis OA of the lens assembly; the first photosensitive surface S1 and the second photosensitive surface S2 are inclined relative to the connecting line O1O2; a first included angle β1 is formed between the first photosensitive surface S1 and the connecting line O1O2; and a second included angle β2 is formed between the second photosensitive surface S2 and the connecting line O1O2.

For instance, in the embodiment of the present disclosure, at least one of the first included angle β1 or the second included angle β2 is not zero. Accordingly, the first photosensitive surface S1 is inclined and the second photosensitive surface S2 is perpendicular to the optical axis OA of the lens assembly; or the second photosensitive surface S2 is inclined and the first photosensitive surface S1 is perpendicular to the optical axis OA of the lens assembly; or both the first photosensitive surface S1 and the second photosensitive surface S2 are inclined.

Herein, for the sake of convenient description, the first included angle and the second included angle refer to angles formed between the connecting line O1O2 and the photosensitive surfaces, respectively. For instance, each angle may be a clockwise angle or a counterclockwise angle.

It is noted that: in the embodiment of the present disclosure, for the sake of simplification and convenient description, the center point of the photosensitive surface may be equivalent to the center point of the image sensor.

Exemplarily, at least one of the first included angle β1 or the second included angle β2 is greater than 0° and less than or equal to 90°.

As shown FIG. 2, since the photosensitive surface is inclined, the distance from an image point of an object to be measured on the image sensor to the center point of the photosensitive surface can be increased, so that the distance measuring precision can be improved under a condition that the density of the image sensors is constant.

For instance, in order to further improve the distance measuring precision, at least one of the first included angle β1 or the second included angle β2 may be greater than or equal to 70° and less than 90°. But the embodiments of the present disclosure are not limited thereto. For instance, at least one of the first included angle β1 or the second included angle β2 may be other angles, e.g., greater than or equal to 50°, 55°, 60° or 65° and less than 90°.

Exemplarily, the first included angle may be equal to the second included angle. The example in FIG. 2 only shows the instance that the first included angle is equal to the second included angle. But the embodiments of the present disclosure are not limited thereto.

It is noted by an ordinary skill in the art that: the inclining angle of the first image sensor relative to the connecting line O1O2 may be not equal to the inclining angle of the second image sensor relative to the connecting line O1O2, and the two inclining angles may be slightly different; or one of the first image sensor and the second image sensor may be inclined and the other one may be not inclined. Exemplarily, the first image sensor and the second image sensor are symmetrically arranged relative to an axis which runs through a midpoint of the connecting line O1O2 of the first center point and the second center point and is perpendicular to the connecting line, namely the optical axis OA of the lens assembly, as shown by the example in FIG. 2.

In one or more implementations, as for a single-lens binocular parallax distance measuring module, as shown in FIG. 2, the camera 100 may also include an optical splitting system 30 which is disposed in the optical path from the lens assembly 10 to the first mirror 21 and the second mirror 22, and configured to transmit the imaging light L from the lens assembly 10 to the first mirror 21 and the second mirror 22, respectively.

It is noted that: for the convenience of description, description is given in FIG. 2 by taking the light L vertically incident into the lens assembly as an example. But the embodiments of the present disclosure are not limited thereto. For instance, light from the object to be measured may also be obliquely incident into the camera lens.

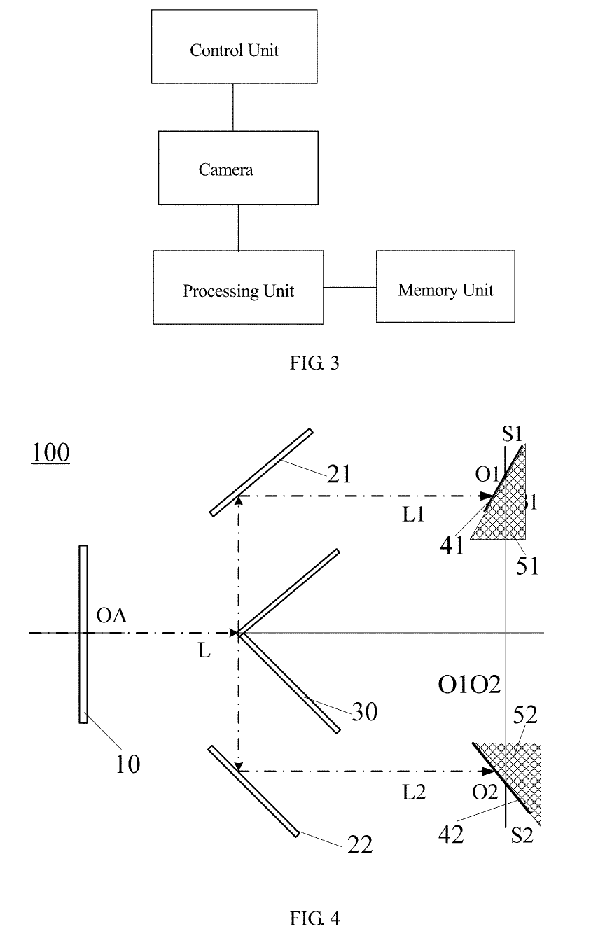

Exemplarily, as shown in FIG. 3, the distance measuring module provided by the first embodiment of the present disclosure not only includes the camera but also may include: a memory unit configured to store image information shot by the camera; a processing unit configured to process the image information; and a control unit configured to control the shooting action of the camera.

The memory unit, for instance, may be a read-only memory (ROM) or a random access memory (RAM), e.g., a flash memory. The control unit may be a motor, or the like.

For instance, the processing unit may be a digital signal processor (DSP). The two image sensors may share one DSP, or respectively adopt respective DSP. The DSPs may be implemented by a general-purpose computing device or a special-purpose computing device.

Exemplarily, the lens assembly in the embodiment of the present disclosure may be implemented by any micro lens made from glass or plastic materials, and the camera 100 may also be a camera provided with an infrared filter.

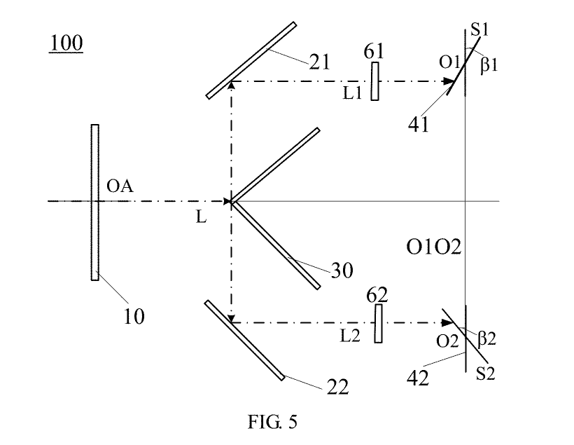

Exemplarily, the camera 100 may also include: a first optical module 61 disposed between the first mirror 21 and the first image sensor 41 and configured to lead the imaging light emitted from the mirror 21 to the first image sensor 41; and a second optical module 62 disposed between the second mirror 22 and the second image sensor 42 and configured to lead the imaging light emitted from the second mirror 22 to the second image sensor 42, as shown in FIG. 5. The first optical module 61 and the second optical module 62 are, for instance, one group of optical elements, e.g., lenses and/or mirrors.

Exemplary description will be given below to the inclined arrangement mode of the first image sensor and the second image sensor in the distance measuring module.

### First Example

Exemplarily, in order to obliquely arrange the image sensors, the distance measuring module may include a loading platform; the first image sensor 41 and the second image sensor 42 may be disposed on the loading platform; and the loading platform may be directly disposed on an outer housing of the distance measuring module.

Exemplarily, a single loading platform may be provided; a side surface provided with the first image sensor and a side surface provided with the second image sensor, of the loading platform, are inclined relative to the connecting line O1O2 of the first center point O1 and the second center point O2, and the inclining angle of the side surface is the same as the included angle between the first image sensor or the second image sensor, disposed on the side surface, and the connecting line O1O2. On the other hand, due to process deviation, the angles may not be strictly equal but slightly different, and the deviation is within a tolerance or an allowable error range. For instance, a side surface of the loading platform provided with a first camera and a side surface provided with a second camera may be symmetrically relative to an axis which runs through the midpoint of the connecting line O1O2 of the first center point O1 and the second center point O2 and is parallel to the optical axis OA.

For instance, two loading platforms may be provided; each image sensor is respectively disposed on the independent loading platform; a side surface of each loading platform provided with the image sensor is inclined relative to the connecting line O1O2; and the inclining angle relative to the connecting line O1O2 is equal to the inclining angle of the image sensor, disposed on the loading platform, relative to the connecting line O1O2. FIG. 4 is a structural view of one example of the distance measuring module provided by the embodiment of the present disclosure. As shown in FIG. 4, the first image sensor 41 and the second image sensor 42 are respectively disposed on loading platforms 51 and 52.

Exemplarily, the cross section of the loading platform may be a triangle as shown in FIG. 4, or may be a trapezoid. But the embodiments of the present disclosure are not limited thereto. For instance, the shape of the cross section of the loading platform may also be set to be the shape which allows the inclining angles of the first image sensor and the second image sensor relative to the connecting line O1O2 to be equal to the inclining angles of corresponding image sensors.

Herein, the loading platforms may be made from insulating materials having supporting function, and the image sensors may be mounted on the loading platform(s) by multiple ways. For instance, a mounting groove may be formed in the loading platform(s); an inner wall of the mounting groove may be provided with threads; each image sensor may be accommodated into a shell; an outer wall of the shell may be provided with threads; in this way, the image sensor can be fastened by threaded engagement; or mounting holes may be formed in the loading platform(s), and the image sensor is fixed or fastened on the loading platform(s) by rivets, bolts, or the like. But the embodiments of the present disclosure are not limited thereto.

In addition, for instance, through holes may be formed in the loading platform(s), and a connector of the image sensor is electrically connected to a printed circuit board (PCB) or a flexible circuit board via the through holes.

Exemplarily, the image sensor may also be disposed in a tilting way via a rigid support provided with a bend angle at a thin end of the rigid support. For instance, the image sensor is fixed on the rigid support by bolts and rivets; one end of the rigid support provided with the bend angle is fixed on the outer housing of the distance measuring module; and the bend angle may be equal to the inclining angle of the image sensor relative to the connecting line O1O2.

### Second Example

The first image sensor 41 and the second image sensor 42 may be respectively disposed on two PCBs; each PCB may be disposed in a tilt way; and the tilt of the image sensor relative to the connecting line O1O2 is achieved by the tilted arrangement of the PCB.

Exemplarily, the two PCBs provided with the image sensors may be further disposed on a loading platform(s) provided with two inclined slopes; and the loading platform(s) is/are disposed on the outer housing of the distance measuring module.

For instance, the two inclined slopes may be symmetrical relative to the optical axis OA, and the slope angle of each inclined slope is equal to the inclining angle of the two image sensors relative to the connecting line O1O2, respectively. The slope angle of the inclined slope and the inclining angle of the image sensor may be slightly different within the tolerance range, which shall fall within the scope of the embodiments of the present disclosure.

Exemplarily, the cross section of loading platform(s) provided with the inclined slopes may be an isosceles triangle or an isosceles trapezoid. The embodiments of the present disclosure are not limited thereto.

In addition, the two PCBs provided with the first image sensor 41 and the second image sensor 42 may be disposed on one loading platform or disposed on two loading platforms, respectively. Herein, the loading platform in the first example is also applicable to the second example. In this way, no further description will be given here to the structure of the loading platform.

The mounting mode of the two PCBs and the loading platforms may adopt riveting, welding, bolted connection, or the like, so that the fixed connection of the PCBs can be achieved. But the embodiments of the present disclosure are not limited thereto.

Description is given above only to the connecting and fixing ways for the instance that the inclining angles of the first camera and the second camera relative to the connecting line O1O2 are equal to each other. But it can be readily contemplated by an ordinary skill in the art that the above ways are also applicable to the instance of unequal inclining angles. The slight difference is in that: for instance, for the loading platform, in the instance that the inclining angles are not equal to each other, the inclining angles of the surfaces provided with the image sensors relative to the connecting line O1O2 correspond to the inclining angles of the image sensors, so the inclining angles of the surfaces provided with the image sensors relative to the connecting line O1O2 are also different from each other. Other connecting and fixing ways are also similar. For the sake of clear and simple description, no further description will be given here.

It should be noted by an ordinary skill in the art that: in an embodiment of the present disclosure, for instance, a camera, with a resolution of 1280*720, a horizontal and vertical field of view FOV(α, β) of FOV(75,60), and a focal length of 2.4 mm, may be adopted.

Exemplarily, the first image sensor and the second image sensor in the embodiments of the present disclosure may be image sensors of the same type or different types. The image sensor may be a charge-coupled device (CCD) image sensor, a complementary metal-oxide semiconductor (CMOS) image sensor, or the like; or the two image sensors may be CCD image sensors, CMOS image sensors or the like with different specifications. But the embodiments of the present disclosures are not limited thereto.

In the distance measuring module provided by the embodiments of the present disclosure, as the two image sensors are inclined relative to the connecting line of the center points of the two photosensitive surfaces of the two image sensors, the distance between the image point of the same object formed in each of the two image sensors and the center point of the image sensor can be increased. In this way, the distance measuring precision can be improved and the measuring range can be widened. Moreover, the distance measuring module provided by the embodiments of the present disclosure can improve the measuring precision on the long-distance object without changing the size of the current distance measuring module, which is advantageous in the miniaturization and the ultrathin design of the distance measuring module and the 3D scanning system for accommodating the distance measuring module, and improvement of the portability. Moreover, for instance, as the two image sensors in the 3D camera module have exactly the same inclining angle, the distance measuring precision on the long-distance object can be further improved, which is more advantageous in the miniaturization and the ultrathin design of the distance measuring module and the 3D scanning system for accommodating the distance measuring module can be more conducive to achieve; and the portability can be further improved.

Herein, it should be noted that the foregoing only illustrates the proposal of inclined arrangement of the image sensors. Moreover, for instance, the distance measuring precision may also be improved by adjusting the deflection angle of the first mirror and the second mirror in the distance measuring module. For instance, the projection position and the projection angle of the imaging light reflected by the mirror on the image sensor is adjusted by adjusting the deflection of the mirror, so that the distance from an image point of an object formed on the image sensor to the center of the photosensitive surface of the image sensor can be increased, and the distance measuring precision can be improved. The proposal of adjusting the mirrors may be independently used, or may be combined with the proposal of the inclined arrangement of the image sensors. But the embodiments of the present disclosure are not limited thereto. For instance, other usage modes capable of increasing the distance from the image point of the object formed on the image sensor to the center of the photosensitive surface may also be adopted.

In addition, an embodiment of the present disclosure also provides a distance measuring method, particularly a distance measuring method using any of the distance measuring modules. The distance measuring method provided by the embodiment of the present disclosure includes following steps.

S1: taking an image of an object via the camera of the distance measuring module; and

S2: determining the vertical distance h from the object to be measured to the camera according to two image points of the object to be measured formed in the first image sensor and the second image sensor of the camera.

The camera includes a lens assembly. The lens assembly includes a lens group and has an optical axis. The camera also includes a first mirror and a second mirror which are configured to reflect imaging light from the lens assembly. The first image sensor corresponds to the first mirror and is configured to receive imaging light from the first mirror for imaging. The first image sensor includes a first photosensitive surface having a first center point. The second image sensor corresponds to the second mirror and is configured to receive imaging light from the second mirror for imaging. The second image sensor includes a second photosensitive surface having a second center point.

A connecting line of the first center point and the second center point is perpendicular to the optical axis of the lens assembly. The first photosensitive surface and the second photosensitive surface are inclined relative to the connecting line of the first center point and the second center point. A first included angle is formed between the first photosensitive surface and the connecting line. A second included angle is formed between the second photosensitive surface and the connecting line. At least one of the first included angle or the second included angle is not zero.

In the distance measuring method using the foregoing distance measuring module, provided by the embodiment of the present disclosure, the two image sensors are inclined relative to the connecting line of the center points of the photosensitive surfaces, the distance from an image point of the same object formed in each of the two image sensors to the center point of the photosensitive surface can be extended or prolonged. In this way, the distance measuring precision can be improved and the measuring range can be widened.

In addition, an embodiment of the present disclosure also provides a 3D scanning system, which includes the distance measuring module provided by the embodiments.

The 3D scanning system provided by the embodiment of the present disclosure further includes: an housing, in which the distance measuring module is disposed on the inside or the outside of the housing.

For instance, when the distance measuring module is disposed on the inside of the housing, the housing is provided with a camera hole, and the lens assembly of the distance measuring module is exposed to the outside through the camera hole.

For instance, when the distance measuring module is disposed on the outside of the housing, the distance measuring module also includes a shell for accommodating the lens assembly, the image sensors, the DSPs, or the like of the distance measuring module. The distance measuring module is connected to a main control circuit of the 3D scanning system through a lead, a universal serial bus (USB) interface, a serial interface, or a parallel interface. For instance, the 3D scanning system also includes an output device, such as a display screen.

Exemplarily, the 3D scanning system provided by the embodiment of the present disclosure may be a tablet PC, a smart mobile phone, a notebook computer, a desktop, a navigator, or the like. The distance measuring module provided by the embodiment of the present disclosure may also be applied in other terminal devices. The embodiments of the present disclosure are not limited thereto.

In addition, it should be noted that description is given in the embodiments of the present disclosure by only taking the binocular parallax distance measuring module provided with two image sensors, the 3D scanning system and the distance measuring method using the two image sensors as examples, the technical proposals of the embodiments of the present disclosure are also applicable to a distance measuring module provided with a plurality of image sensors, a 3D scanning system and a distance measuring method using a plurality of image sensors. For instance, some image sensors are inclined and the remaining image sensors are not inclined, or all the image sensors are inclined. The embodiments of the present disclosure are not limited thereto. In addition, it should be noted that the optical axis of the lens assembly in the embodiments of the present disclosure refers to a primary optical axis and is a connecting line of lens centers of coaxial lenses in the lens group of the lens assembly.

In the 3D scanning system including the distance measuring module, provided by the embodiments of the present disclosure, the two image sensors are inclined relative to the connecting line of the centers of the photosensitive surfaces of the two image sensors, the distance from an image point of an object formed in each of the two image sensors to the center of the photosensitive surface can be increased. In this way, the distance measuring precision can be improved and the measuring range can be widened. Moreover, the distance measuring precision can be improved without increasing the size of the distance measuring module, so the miniaturization and the ultrathin design of the 3D scanning system can be achieved, and the portability can be improved.

Herein, it should be noted that the foregoing is the proposals of inclined arrangement of the image sensors. Moreover, the distance measuring precision may also be improved by adjusting the deflection angle of the first mirror and the second mirror in the distance measuring module. For instance, the projection position and the projection angle of the imaging light reflected by the mirror on the image sensor is adjusted by adjusting the deflection of the mirror, so that the distance from an image point of an object formed on the image sensor to the center of the photosensitive surface of the image sensor can be increased, and the distance measuring precision can be improved. The proposal of adjusting the mirror may be independently used or may be combined with the proposal of inclined arrangement of the image sensors. But the embodiments of the present disclosure are not limited thereto. For instance, other usage modes capable of increasing the distance from the image point of the object formed on the image sensor to the center of the photosensitive surface may also be adopted. The described above are only exemplary embodiments of the present disclosure, and the present disclosure is not intended to be limited thereto. For one of ordinary skill in the art, various changes and alternations may be made without departing from the technical scope of the present disclosure, and all of these changes and alternations shall fall within the scope of the present disclosure.

The application claims priority to the Chinese patent application No. 201610099285.8, filed on Feb. 23, 2016 and entitled “Distance Measuring Module, 3D Scanning System and Distance Measuring Method”, which is incorporated herein by reference in its entirety.

1. A distance measuring module, comprising a camera, wherein the camera comprises:
a lens assembly comprising a lens group and having an optical axis;
a first mirror and a second mirror configured to reflect imaging light from the lens assembly;
a first image sensor corresponding to the first mirror, being configured to receive imaging light from the first mirror for imaging, and comprising a first photosensitive surface provided with a first center point; and
a second image sensor corresponding to the second mirror, being configured to receive imaging light from the second mirror for imaging, and comprising a second photosensitive surface provided with a second center point;
wherein a connecting line of the first center point and the second center point is perpendicular to the optical axis of the lens assembly; the first photosensitive surface and the second photosensitive surface are inclined relative to the connecting line of the first center point and the second center point; a first included angle is formed between the first photosensitive surface and the connecting line; a second included angle is formed between the second photosensitive surface and the connecting line; and at least one of the first included angle or the second included angle is not zero.

2. The distance measuring module according to claim 1, wherein at least one of the first included angle or the second included angle is greater than 0°, and less than 90°.

3. The distance measuring module according to claim 2, wherein at least one of the first included angle or the second included angle is greater than or equal to about 70°, and less than 90°.

4. The distance measuring module according to claim 3, wherein the first included angle and the second included angle are substantially equal to each other.

5. The distance measuring module according to claim 4, wherein the first image sensor and the second image sensor are symmetrically arranged relative to an axis which runs through a midpoint of the connecting line of the first center point and the second center point and is perpendicular to the connecting line.

6. The distance measuring module according to claim 3, wherein the first included angle is not equal to the second included angle.

7. The distance measuring module according to claim 1, wherein the camera further comprises:
an optical splitting system disposed in an optical path from the lens assembly to the first mirror and the second mirror, and configured to transmit the imaging light from the lens assembly to the first mirror and the second mirror, respectively.

8. The distance measuring module according to claim 1, further comprising:
a memory unit configured to store image information shot by the camera;
a processing unit configured to process the image information; and
a control unit configured to control the shooting action of the camera.

9. The distance measuring module according to claim 1, further comprising: a loading platform,
wherein the first image sensor and the second image sensor are disposed on the loading platform, and
a side surface provided with the first image sensor and a side surface provided with the second image sensor, of the loading platform, are inclined relative to the connecting line of the first center point and the second center point.

10. The distance measuring module according to claim 1, further comprising: at least two loading platforms configured to mount the first image sensor and the second image sensor, respectively, wherein
a side surface provided with the first image sensor and a side surface provided with the second image sensor, of the two loading platforms, are inclined relative to the connecting line of the first center point and the second center point.

11. The distance measuring module according to claim 1, further comprising: at least two printed circuit boards (PCBs), wherein the first image sensor is disposed on one PCB, and the second image sensor is disposed on the other PCB; and the two PCBs are inclined relative to the connecting line of the first center point and the second center point.

12. The distance measuring module according to claim 1, wherein the first image senor and the second image sensor are charge-coupled device (CCD) image sensors or complementary metal-oxide semiconductor (CMOS) image sensors.

13. The distance measuring module according to claim 1, wherein a deflection angle of the first mirror and/or a deflection angle of the second mirror are/is adjusted to increase a distance from an image of an object to be measured formed on the first image sensor and/or the second image sensor to a center of the photosensitive surface of corresponding image sensor.

14. The distance measuring module according to claim 1, further comprising: a first optical module disposed between the first mirror and the first image sensor and configured to lead the imaging light emitted from the first mirror to the first image sensor; and a second optical module disposed between the second mirror and the second image sensor and configured to lead the imaging light emitted from the second mirror to the second image sensor.

15. A three-dimensional (3D) scanning system, comprising the distance measuring module according to claim 1.

16. The 3D scanning system according to claim 15, further comprising: a housing, wherein the housing is provided with a camera hole; the distance measuring module is mounted on the inside of the housing; and the lens assembly is exposed to the outside through the camera hole.

17. The 3D scanning system according to claim 15, further comprising: a housing, wherein the distance measuring module is mounted on the outside of the housing.

18. A distance measuring method using a distance measuring module, comprising:
shooting an image of an object to be measured via a camera of the distance measuring module; and
determining a vertical distance h from the object to be measured to the camera according to two images of the object to be measured formed in the first image sensor and the second image sensor of the camera,
wherein the camera comprises: a lens assembly comprising a lens group and having an optical axis; and a first mirror and a second mirror configured to reflect imaging light from the lens assembly;
the first image sensor corresponds to the first mirror and is configured to receive imaging light from the first mirror for imaging; the first image sensor comprises a first photosensitive surface having a first center point; the second image sensor corresponds to the second mirror and is configured to receive imaging light from the second mirror for imaging; the second image sensor comprises a second photosensitive surface having a second center point;
a connecting line of the first center point and the second center point is perpendicular to an optical axis of the lens assembly; the first photosensitive surface and the second photosensitive surface are inclined relative to the connecting line of the first center point and the second center point; a first included angle is formed between the first photosensitive surface and the connecting line; a second included angle is formed between the second photosensitive surface and the connecting line; and at least one of the first included angle or the second included angle is not zero.
